(19) United States
(12) Patent Application Publication
(10) Pub. No.: US 2007/0198747 A1
(43) Pub. Date: Aug. 23, 2007

(54) Method for processing a demand from a user of a digital terminal

(76) Inventors: Noemie Simoni, Savigny Sur Orge (FR); Philippe Coude, Epinay Sur Orge (FR); Antoine Boutignon, Paris (FR); Arnaud de Moissac, Paris (FR)

Correspondence Address: PERMAN & GREEN, 425 POST ROAD, FAIRFIELD, CT, 06824, US

(21) Appl. No.: 11/616,578

(22) Filed: Dec. 27, 2006

(30) Foreign Application Priority Data
Dec. 27, 2005 (FR) 05 54098

(51) Int. Cl. G06F 15/16

(52) U.S. Cl. 709/249

(57) ABSTRACT

To make the processing of a user request more fluid, a terminal of the user firstly sub-divides this request into resources to be implemented in order to meet the request. Secondly, for each resource, the terminal constantly maintains a list of offerers capable of offering the service linked to a resource. These lists comprise the services detected by the terminal and correspond to preferences expressed by the user of the terminal.

### BACKGROUND

1. Field

An object of the invention is a method for processing a demand from a digital terminal user. The field of the invention is that of networks and more particularly telecommunications networks accessible from mobile terminals. A mobile terminal or an “any time anywhere” terminal is generally speaking a terminal that can be carried in the pocket of a garment and can login to a telecommunications network, for example a network of a mobile telephony operator.

2. Description

There are different access technologies in the prior art potentially enabling a user to select the technology most suited to his needs. However, the coexistence of heterogeneous technologies brings high-level complexity to the environment in which a service is performed on a given terminal, using these technologies. Optimum execution, or at least appropriate execution, then depends on different factors, among them the localization of the user in space and time, the network environment, the context of execution, the capacities of the user's terminal, etc.

A new generation of services has appeared with the convergence of classic telecommunications and the modern world of the Internet. The new services (multimedia services, data services, Internet services) can be used differently by users depending on their preferences and/or their capacities. Consequently, in this new configuration, the human factor is becoming of utmost importance in the design and creation of a service. Users should be able to define their preferences and personalize their services. The personalizing and the preferences vary according to different static and dynamic factors. Personalization is one of the keys to the viability of a service. It should be possible to store and exploit personalization data in an interoperable and dynamic way for each actor. This is not the case in the prior art.

It must be noted that present-day telecommunications systems are limited in terms of portability of services and rapid deployment of services.

In response to this last-named point, several initiatives have emerged for opening networks and making them accessible to third-party service providers. These initiatives are, for example, the OSA (Open Service Access) method whose specifications are given by the 3GPP, reference 22.127 and especially the version 5.3.0 of this document. Another initiative is called the JAIN (Java Advanced Intelligent Network) which is a network access program interface for JAVA. These initiatives are grouped together under the names EAI (Enterprise Application Integration) and Web Services.

In the case of Web services, EAIs, all the components of the system are services that format behavior/data and communicate with other components through an interface of a communications application to which said components access via standardized functions. Such functions are called APIs (Application Program Interfaces). The protocol used for these communications are, for example, SOAP (Simple Object Access Protocol) and/or WSDL (Web Services Description Language).

These technologies, in their specific features, illustrate the fact that the main preoccupation of these systems is to increase the number of interfaces in order to increase interoperability between the applications. In other words, the goal of these systems is to make access to data transparent for the applications. This approach does not achieve quality-of-service management and, even less does it quality-of-service management between a user and the service asked for by the user, herein called end-to-end quality of service.

Another problem of the prior art is its decentralized nature and the fact that it is set up in client-server form which dictates a management infrastructure for the servers themselves through other servers. This creates a chain between the customer and the server in which each link is capable of malfunctioning.

Each link is vital in the customer-server relationship. This results in a possible deterioration of general performance. These drawbacks are due to the fact that several apparatuses are crossed during communications between the server and the customer.

The invention resolves these problems by setting up an intermediate-layer or mid-layer software program also called a “middleware” program. This intermediate-layer software carries out, firstly, a continuous updating of the user's “infosphere” and, secondly, a filtering of collected information associated with preferences expressed by the user of the device. The user's “infosphere” is the term applied herein to all the data on the user and means of using this data. This association results in an active profile that is used to produce responses to requests expressed by the user mentioned here above. The user's preferences incorporate personal data as well as data pertaining to presentation, quality of service and/or means to be implemented to meet a request expressed by said user.

A third step of the method is used to compute all the possibilities of implementation as a function of the constraints of each element of the chain in anticipating possible malfunctions in order to meet the user's requirement.

### SUMMARY

An object of the invention therefore is a method for the processing of a demand by a user of a mobile terminal through said mobile terminal, wherein the method comprises the following steps implemented by the mobile terminal:

the collection of all the data on a user identified by user code and of the means of using this data, the collected data being of at least four types: personal, available processing resources, available communications resources and characteristics of the terminal,

the production of a profile corresponding to the user and the recording of said profile in a memory,

the expressing of the demand by the user of the terminal,

the cross-checking of the expressed demand with the profile produced to build a private user network of elements of the profile enabling the demand to be met,

the implementing of the private user network built.

Advantageously again according to the invention, the collection of the data and the production of the profile are carried out constantly in order to take account of changes in the environment of the terminal.

Advantageously again according to the invention, the production of the profile is done according to a scheduler.

Advantageously again according to the invention, a piece of information on quality of service is dynamically associated with each element of the profile having a processing-resource nature and a communications-resource nature.

Advantageously again according to the invention, the private user network of elements enabling the demand to be met is built as a function of a minimum quality to be attained for the demand to be met.

Advantageously again according to the invention, the malfunctioning of an element in the private user network built to meet the demand leads to the replacement of this element by another element which is an equivalent element in the profile.

Advantageously again according to the invention, a production task of the profile consists of the maintaining, whenever possible and for each element of the profile, of a list of equivalent elements.

Advantageously again according to the invention, in order to be cross-checked with the available resources, a demand is sub-divided into a sequence of resources to be implemented in order to meet the demand.

### BRIEF DESCRIPTION OF THE DRAWINGS

The invention will be understood more clearly from the following description and the accompanying figures. These figures are given a purely by way of an indication and in no way restrict the scope of the invention. Of these figures:

FIG. 1 illustrates steps of the method according to the invention;

FIG. 2 illustrates the evolution of an active profile in time,

FIG. 3 illustrates a network comprising a plurality of terminals and servers,

FIG. 4 illustrates steps in a subscription to a service,

FIG. 5 provides a generic illustration of the processing of a demand.

### MORE DETAILED DESCRIPTION

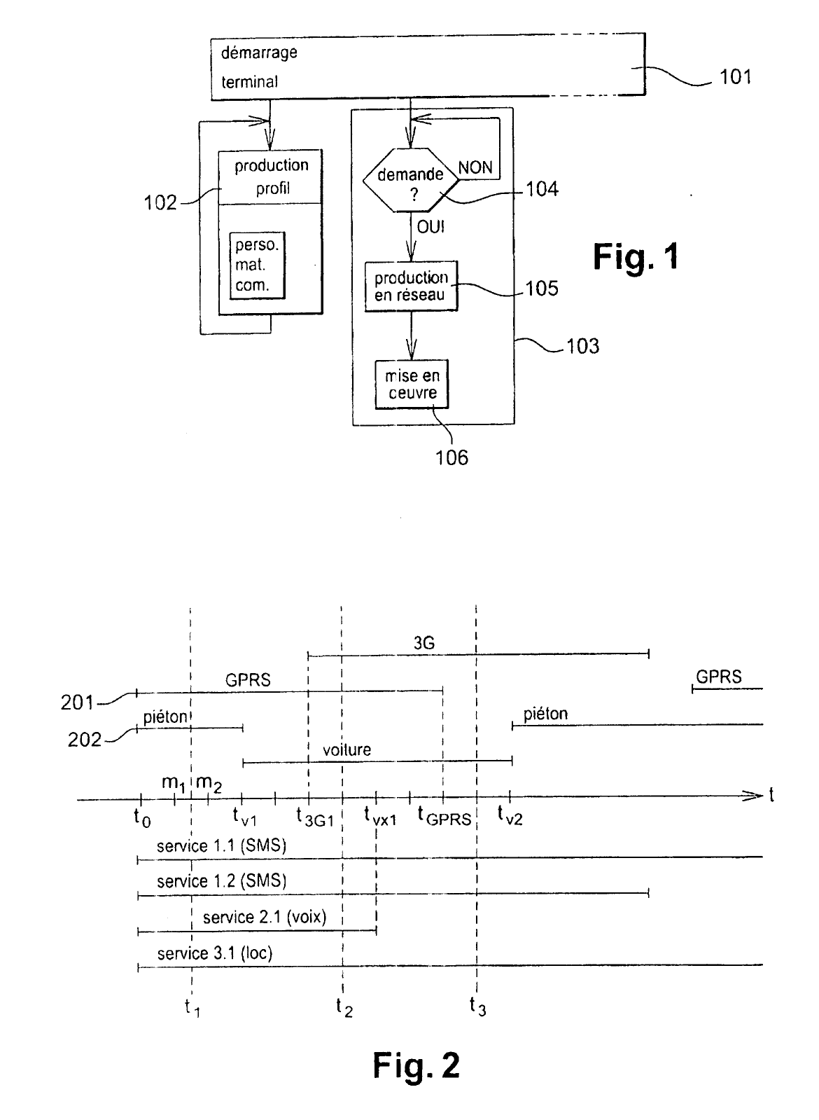

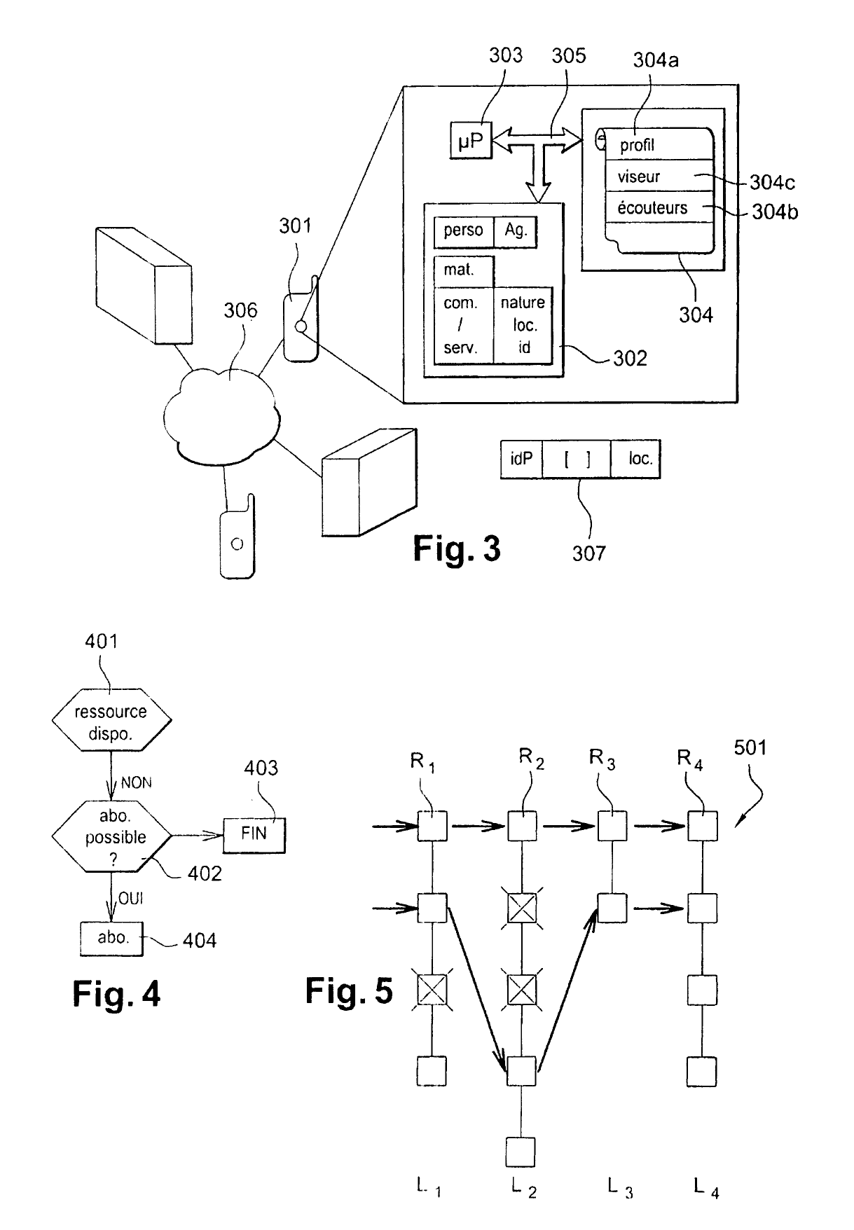

FIG. 1 shows a preliminary step 101 for starting a terminal, for example the terminal 301 shown in FIG. 3. The terminal 301 is, for example, a mobile telephony apparatus. In practice, such a terminal may be any device whatsoever capable of linking up to a telecommunications network. In particular, such a device may be a personal digital assistant or a personal computer. The terminal 301 is connected, through a network 306, to other terminals and/or servers.

At its booting 101, the terminal 301 launches a classic initialization or booting sequence and then, according to the invention, launches at least one process 102 for the production of a profile. The process 102 consists of the collection and recording of information for subsequent use to meet a request of a user of the terminal 301.

One particular feature of the invention is that this process of production of a profile is constant once the terminal starts. The term “constant” must be understood to mean either that the terminal executes the process 102 in a multitask environment in which case the task corresponding to the process never stops or that the process 102 is launched at regular intervals. It is noted here that the process 102 can be launched at regular intervals in a multitask environment.

In one implementation of the invention, the production of the profile is achieved by two simultaneous processes: a first process called an ambiance process which constantly collects information on the user thus creating his infosphere and a filtering process which produces an active profile that corresponds to the information on the infosphere filtered and/or sorted out according to the user's preferences. It is necessary here to clearly understand what the user's infosphere is. The infosphere is actually all the information that the terminal 301 is capable of collecting on its user. This information therefore relates not only to identifier type data, passwords, preferences and instances of personalization but also to the capacities of the apparatus used by the user and that of apparatuses to which said apparatus used by the user can get linked up. These capacities are expressed in terms of aptitude for sound restitution, aptitude for graphic restitution, processing capacity, transmission/reception capacity etc.: this list is not exhaustive.

### MORE DETAILED DESCRIPTION

FIG. 1 shows that the processing of the information by the process 102 relates to the following information:

personal information such as the name, address, electronic identifiers for example of the electronic mail and/or instantaneous type, preferably in the mode of implementing a service, etc.,

hardware information such as the power of the terminal microprocessor, the display capacities of the terminal, the sound rendition capacities of the terminal etc.,

communications-related information and, more generally, information on services that the terminal is capable of implementing. Among the communications resources, at least the following are known: the different mobile telephony operators, the local connection means such as the local wireless networks (of the Wifi, Bluetooth or DECT type) or cable-based networks (of the Ethernet type).

This information, once collected, is recorded in a profile memory 302 of the terminal 301. The memory 302 is itself divided into two zones, one zone to record the infosphere and one zone to record the profile known as the active profile which corresponds to the filtering of the infosphere by the user's preferences. This localization is both spatial and temporal. This is achieved by means of a scheduler by which the application of the preferences can be dated. This is also achieved by the association of each preference with a localization of the following type: car, country, name of town, etc. FIG. 3 shows an input 307 of a scheduler according to the invention. Such an input 307 comprises at least one field idP identifying the preference, for example a telecommunications network or a service, a field [ ] specifying a time slot or window and a loc. field specifying a localization.

In one variant, the user's profile is recorded not in the terminal itself but in a memory accessible to the terminal through a network connection for example. This amounts to recording the profile of the user on a profile server. From this perspective, the profile itself becomes a resource whose availability for meeting a request must be taken into account. This implementation enables the implementation of the invention in terminals with low memory capacity and/or low processing capacities.

This variant can be further elaborated by recording one part of the user's profile on the terminal and the complementary part on a server. The part recorded in the terminal corresponds, in this case, to a profile filtering operation relative to the geographical localization of the terminal. In other words, only the most immediately relevant information is recorded in the terminal.

In these variants, it is also possible to envisage a situation where the processing of a request, described further above in the description can be shifted to the profile server instead of being performed by the terminal. In this case, the response to the request is transmitted to the terminal.

Thus, for any time and space localization, the process 102 is capable of producing the active profile desired by the user. This means of working by scheduler also makes it possible to anticipate the user's demands. Indeed, the scheduler can be used to enter resources that the user might need, depending on a localization, into the active profile.

In general, the terminal 301 is a device comprising a microprocessor 303 controlled by instruction codes recorded in a program memory 304, the elements 302 to 304 being interconnected by a bus 305. The terminal 301 also has other components, not shown, especially input/output components enabling it to communicate with its user and/or the surrounding telecommunications networks. When an action is attributed to a device, this action is actually performed by a microprocessor of the device controlled by instruction codes recorded in a program memory of the device.

The memory 302 is, for example, structured as a grid comprising several zones, one zone for personal data, one zone for hardware data and one zone for communications data and services.

In practice, each communications resource or service resource is identified by a single identifier and is described by a nature and a service localization. A nature is the type of service corresponding to the resource, for example SMS service, broadband connection, localization service, home food-delivery service, information service, payment service etc. A service localization corresponds to technical information used to login to the resource. Such information is, for example, an identifier used to login to the resource through a network. The best-known of these identifiers are the URLs and the IP addresses.

In the invention, the memory 304 therefore has at least one zone 304a corresponding to instruction codes for the updating of resource state information and one zone 304b corresponding to applications known as “listener” applications which study their environment and therefore that of the terminal 301 to discover resources therein. Examples of listeners are, for example, a Bluetooth listener, and SMS service listener, a GPS type localization listener, a mobility listener determining the user's mode of movement etc. The memory 304 also has a zone 304c for the production and implementation of virtual networks.

FIG. 2 illustrates the evolution of a profile in time. At an instant t0, a user powers on the terminal 301. The terminal 301 then launches the exploration service 102. At the instant t0, the terminal 301 detects the fact that a GPRS connection 201 (i.e. a connection via a second-generation mobile telephony network) is possible, that the user is walking 202 and that he has access to services 1.1, 1.2, 2.1 and 3.1.

The services 1 are for example SMS delivery services. The service 2 is, for example, a text-to-voice conversion service, the service 3 is, for example, a localization service. As described here above, there are many other services.

Depending on its programming, the terminal 301 carries out the exploration process at regular intervals m1, m2, . . . , so long as it is powered.

At an instant tv1, the terminal detects the fact that the user is now moving in a car.

At an instant t3G1>tv1, the terminal detects a possibility of connection to a third-generation mobile telephony network.

At an instant tvx1>t3G1 the terminal detects the fact that the service 2.1 is no longer available.

At an instant tGPRS1>tvx1, the terminal detects the fact that the GPRS network is no longer available.

At an instant tv2>tGPRS1, the terminal detects the fact that the user is walking.

The exploration process continues in this way so long as the terminal is powered on.

It is interesting to note here that the terminal 301 makes an inventory, in the active profile 302, of all the available resources in the environment of the terminal, even if this is redundant from a viewpoint of functions. This characteristic has at least two advantages:

a quality of service demanded by the user is taken into account more efficiently through his preferences

there is greater adaptability if there is malfunctioning of a service since the terminal can then replace it by an equivalent service.

FIG. 1 also shows that, when booting, the terminal 301 launches a process 103 for processing requests by the user of said terminal. The processes 102 and 103 are performed in parallel.

The process 103 comprises a preliminary step 104 for listening to the user's request. So long as the user does not express a request, the process 103 remains at the step 104. The user expresses a request, for example through a keyboard of the terminal 301, by selecting a link on a hypertext page or selecting an option in a menu or in any other way.

For example, at a date t1<tv1, the user of the telephone 301 expresses his wish to consult the SMS messages or any other electronic messages that he has received.

The terminal 301 then passes to a step 105 for the production of a virtual network capable of meeting the user's request. Such a network includes all the resources required to fulfill the user's request. In this example, the terminal needs a mode of connection to an SMS distribution server. At the date t1, the GPRS network is available along with two servers capable of distributing SMS messages.

In a step 105 therefore, the terminal 101 produces a virtual network comprising the 1.1 service and a GPRS connection. In the invention, each resource listed in the profile is considered to be a network component and, in this sense, comprises a standardized communications interface as well as properties accessible to the other components, enabling the selection of the component most capable of meeting the user's request.

Once the network has been constituted, it is implemented. In the present example, the terminal 301 therefore uses the GPRS network to login to the SMS distribution server 1.1 and thus retrieve the user's messages. All the information needed for this connection, namely the identifier and the password for example, are also recorded in the user's profile in the zone corresponding to the personal information.

In another example, the user still wishes to retrieve his SMS messages, but at an instant t2 such that t3G1<t2<tvx1. In other words, the user wishes to consult his SMS messages while he in a car. At the step 105, the terminal 301 produces a virtual network in taking account of the fact that the user is in a vehicle. The terminal 301 then includes the component 2.1 in the virtual network, enabling a text message to be converted into a voice message. At the date t2, the terminal 30 has also detected the fact that a third-generation mobile telephony network is available. Depending on the preferences expressed by the user through his profile, the terminal will then use either the second-generation network or the third-generation network. Such a preference is, for example, the lowest-cost connection possible or the fastest connection possible. In the present example, it is assumed that the user has decided to prefer speed. In this case, the virtual network produced has a connection through the third-generation network to the service 1.1 and the service 2.1. The terminal 301 therefore logs in to the service 1.1, and then to the service 2.1 and can thus make voice broadcasts of the SMS messages of the user who is driving his vehicle.

In another example, the user still wishes to retrieve his SMS messages but at an instant t3 such that tGPRS1<t3<tv2. In other words, the user is still in his car but the service 2.1 is no longer available. In this case, it will be announced that the SMS messages are unavailable unless the user has declared a preference for obtaining his SMS messages whatever the circumstances. tGPRS1<t3<tv2.

In the last-named example, the invention provides for another solution in the event of the unavailability of a service. It may happen that a service is available in exchange for payment.

FIG. 4 shows a step 401 for testing the availability of a resource during the production of a virtual network. If the resource is available but not activatable, then the terminal 301 passes to a step 402 in which a test is made to see if the resource is activatable through a subscription to be taken. In this case, the resource has been recorded as such in the profile 302. If this is not so, then the terminal goes to an end step 403, and it is impossible to meet the user's request.

If this is the case, then the terminal verifies that there is a payment resource available, through a connection to a banking service for example. If such a banking service is available, then the terminal passes to a subscription step 404. The step 404 consists of the inclusion, in the final network, of the banking service and the service with which it is desired to take a subscription. It then becomes possible to meet the request; the subscription, when accepted and initialized, causes the resource to pass into the activated state. In this mode of operation, the user specifies, in his profile, the maximum sum for which the terminal is authorized to negotiate automatically for example. If the sum is exceeded, the user is called upon to indicate his consent so that the virtual network continues to be produced.

FIG. 5 provides a general illustration of the processing of a demand. FIG. 5 shows a line 501 corresponding to a breakdown of a demand into a sequence of resources to be implemented. The chosen example illustrates a demand corresponding to the implementation of four resources R1 to R4. Through the step 102, the terminal 301 is capable of associating a list of services with each resource R1 to R4. These lists are derived from the active profile of the user produced at the step 102. The resource R1 has the corresponding list L1 comprising the services S1.1 to S1.3. The resource R2 has the corresponding list L2 comprising the services S2.1 to S2.4. The resource R3 has the corresponding list L3 comprising the services S3.1. The resource R4 has the corresponding list L4 comprising the services S4.1 to S4.3. In the invention, each service has one of four statuses: unavailable, available, activatable and activated. To meet the demand, the terminal 301 selects one service per list to produce the network of services enabling the demand to be met. In the present example, this network comprises the services S1.1, S2.3, S3.1 and S 4.1. In practice, in the list, the services present correspond to the user's preferences. The terminal 301 then selects the first activated service of the list. If no service is activated, then the terminal selects the first activatable service and activates it. If no service is activatable, then the terminal selects the first available service and activates it. If no service is available, then the terminal launches a discovery or subscription procedure described with reference to FIG. 4.

A service is activated if the terminal can use it, i.e., for example, it the service can send data through an open connection to a network.

A service is activatable if the terminal possesses all the information and rights to activate it.

A service is available if the terminal detects it, i.e. if the terminal picks up a telecommunications network but does not have the necessary information available to make it activatable.

A service is unavailable if no activity corresponding to this service is detected.

In this description of the management of states of a service, the term “service” must be understood in a broad sense. Thus, a service here is a service of processing, information distribution (database for example), communications (network) or restitution (input/output peripheral).

In the invention therefore the active profile is a structure recorded in the memory 302. One way of viewing this structure is to imagine it as a list of resources with each resource having a corresponding list of offerers capable of rendering the service linked to the resource. An offerer here is a device with which the terminal 301 is capable of setting up communications.

In one variant of the invention, the above structure associates a quality of service grade with each offerer. This grade is determined during the operations for updating the user's infosphere. It is thus possible to build a network of resources to meet a request according to a quality of service requirement.

In one variant of the invention, the profile 302 is updated as a function of a scheduler. Such a scheduler forms part of the user's personal data. Such a scheduler specifies for example the information that must be sought as a function of the data. A date may then be specified to the minute, the hour, the date or in considering any other form of statement.

In one example, such a scheduler specifies that, on Saturday and Sunday, between 11 am and 1 pm, the terminal must include information in the profile on restaurants located in the vicinity of the terminal. The terminal then sets up a virtual network through which this information can be obtained. Thus, when the user expresses a request to find a restaurant, the response is already available in the profile 302.

With the invention it becomes possible to express a QoS (quality of service) at the level of the service. Indeed, the invention makes it possible to take account of a preference such as “SMS message whatever the circumstances”. A virtual network will be built to this end as illustrated in the case of the implementation of the SMS reception.

Furthermore, each component listed in the profile is associated with grades of availability, reliability, time limit and capacity so that a traditional QoS can be determined for the virtual network and so that this virtual network can thus be adapted to a QoS required by the user. This is made possible through the invention which envisages each resource as a component connectable to a network.

The invention therefore proposes the implementation of a constant process for the prospective exploration of the environment in order to precede expression of a request by a user. The invention is particularly worthwhile because it leads the environment to be everything that the terminal can link up with, namely the user's infosphere. This includes servers as well as terminals of other users. The invention therefore converts a traditional customer-server network into a network of users all operating at the same level and exchanging services. Each terminal can be both asker (customer) and offerer (server).

1- A method for the processing of a demand by a user of a mobile terminal through said mobile terminal, wherein the method comprises the following steps implemented by the mobile terminal:
the collection of all the data on a user identified by user code and of the means of using this data, the collected data being of at least four types: personal, available processing resources, available communications resources and characteristics of the terminal,
the production of a profile corresponding to the user resulting from the continuous updating of the user's infosphere and from a filtering of the collection information associated with preferences expressed by the user and the recording of said profile in a memory, the active profile being used to produce responses to requests expressed by the user while the data collection and the production of the profile are done constantly to take account of the evolution of the environment of the terminal,
the expressing of the demand by the user of the terminal,
the cross-checking of the expressed demand with the profile produced to build a private user network of elements of the profile enabling the demand to be met,
the implementing of the private user network built.

2- A method according to claim 1, wherein the production of the profile is done according to a scheduler.

3- A method according to claim 1, wherein a piece of information on quality of service is dynamically associated with each element of the profile having a processing-resource nature and a communications-resource nature.

4- A method according to claim 3, wherein the private user network of elements enabling the demand to be met is built as a function of a minimum quality to be attained for the demand to be met

5- A method according to claim 1, wherein the malfunctioning of an element in the private user network built to meet the demand leads to the replacement of this element by another equivalent element in the profile.

6- A method according to claim 5, wherein a production task of the profile consists of the maintaining, whenever possible and for each element of the profile, of a list of equivalent elements.

7- A method according to claim 1, in order to be cross-checked with the available resources, a demand is sub-divided into a sequence of resources to be implemented in order to meet the demand.
